(19) United States
(12) Patent Application Publication
(10) Pub. No.: US 2005/0277542 A1
(43) Pub. Date: Dec. 15, 2005

(54) Catalyst regeneration process

(76) Inventors: Mark P. Kaminsky, Media, PA (US); Roger A. Grey, West Chester, PA (US)

Correspondence Address: LYONDELL CHEMICAL COMPANY, 3801 WEST CHESTER PIKE, NEWTOWN SQUARE, PA, 19073, US

(21) Appl. No.: 10/867,507

(22) Filed: Jun. 14, 2004

(51) Int. Cl. B01J 20/34

(52) U.S. Cl. 502/22

(57) ABSTRACT

Used noble metal-containing titanium or vanadium zeolite catalysts, that have been employed in the epoxidation of olefins with hydrogen and oxygen, are regenerated by contacting the spent catalyst with water or an alcohol/water mixture at a temperature of 25° C. to 200° C.

### FIELD OF THE INVENTION

This invention relates to a method for restoring the activity of a noble metal-containing titanium or vanadium zeolite catalyst that has been used to catalyze the epoxidation of olefins with hydrogen and oxygen. Regeneration is accomplished by contacting the spent noble metal-containing titanium or vanadium zeolite catalyst with a water or a mixture of alcohol and water at a temperature of 25° C. to 200° C.

### BACKGROUND OF THE INVENTION

Many different methods for the preparation of epoxides have been developed. Generally, epoxides are formed by the reaction of an olefin with an oxidizing agent in the presence of a catalyst. The production of propylene oxide from propylene and an organic hydroperoxide oxidizing agent, such as ethyl benzene hydroperoxide or tert-butyl hydroperoxide, is commercially practiced technology. This process is performed in the presence of a solubilized molybdenum catalyst, see U.S. Pat. No. 3,351,635, or a heterogeneous titania on silica catalyst, see U.S. Pat. No. 4,367,342. Hydrogen peroxide is another oxidizing agent useful for the preparation of epoxides. Olefin epoxidation using hydrogen peroxide and a titanium silicate zeolite is demonstrated in U.S. Pat. No. 4,833,260. One disadvantage of both of these processes is the need to pre-form the oxidizing agent prior to reaction with olefin.

Another commercially practiced technology is the direct epoxidation of ethylene to ethylene oxide by reaction with oxygen over a silver catalyst. Unfortunately, the silver catalyst has not proved useful in commercial epoxidation of higher olefins. Therefore, much current research has focused on the direct epoxidation of higher olefins with oxygen and hydrogen in the presence of a catalyst. In this process, it is believed that oxygen and hydrogen react in situ to form an oxidizing agent. Thus, development of an efficient process (and catalyst) promises less expensive technology compared to the commercial technologies that employ pre-formed oxidizing agents.

Many different catalysts have been proposed for use in the direct epoxidation of higher olefins. For example, JP 4-352771 and U.S. Pat. Nos. 5,859,265 and 6,008,388 disclose the production of propylene oxide from the reaction of propylene, oxygen, and hydrogen using a catalyst containing a Group VIII metal such as palladium on a crystalline titanosilicate.

Unfortunately, catalysts of the type disclosed above tend to slowly deteriorate in performance when used repeatedly or in a continuous process for a prolonged period of time. In particular, the catalyst activity decreases with time to a point where continued use of the catalyst charge is no longer economically viable. Due to the relatively high cost of synthesizing this type of catalyst, regeneration of the used catalyst would be greatly preferred over replacement.

U.S. Pat. No. 6,380,119 discloses a method of regenerating a zeolite, particularly a titanium silicalite, by a three-stage calcination process in which the temperature is varied from 250-800° C. and the oxygen content is varied over the three stages. Baiker et al., App. Catal. A: General 208 (2001) 125, discloses the washing of a used Pd-Pt/TS-1 catalyst with refluxing methanol to partially remove non-volatile organic residue from the catalyst. In addition, Baiker speculates that reactivation of the Pd-Pt/TS-1 catalyst requires an oxidative treatment at elevated temperatures, but that earlier work indicates that such a treatment would result in reduced catalytic performance. U.S. Pat. No. 5,859,265 also states that a palladium titanium silicalite catalyst may be regenerated by either a simple wash process or by a controlled burn at 350° C. followed by reduction.

As with any chemical process, it is desirable to develop new and improved regeneration methods. We have discovered an effective regeneration method to restore the activity of a used noble metal-containing titanium or vanadium zeolite catalyst.

### SUMMARY OF THE INVENTION

The invention provides a method of regenerating a used noble metal-containing titanium or vanadium zeolite catalyst that has been employed in the epoxidation of olefins in the presence of hydrogen and oxygen. The regeneration method comprises contacting the used catalyst with water or a mixture of alcohol and water at a temperature of 25° C. to 200° C.

### DETAILED DESCRIPTION OF THE INVENTION

The catalysts regenerable by practice of the present invention are noble metal-containing titanium or vanadium zeolite catalysts. Noble metal-containing titanium or vanadium zeolite catalysts are well known in the art and are described, for example, in JP 4-352771 and U.S. Pat. Nos. 5,859,265 and 6,555,493, the teachings of which are incorporated herein by reference in their entirety. Such catalysts typically comprise a titanium or vanadium zeolite and a noble metal, such as palladium, gold, platinum, silver, iridium, ruthenium, osmium, or combinations thereof. The catalysts may contain a mixture of noble metals. Preferred catalysts comprise palladium and a titanium or vanadium zeolite, palladium, gold, and a titanium or vanadium zeolite, or palladium, platinum, and titanium or vanadium zeolite.

Titanium or vanadium zeolites comprise the class of zeolitic substances wherein titanium or vanadium atoms are substituted for a portion of the silicon atoms in the lattice framework of a molecular sieve. Such substances are well known in the art. Particularly preferred titanium zeolites include the class of molecular sieves commonly referred to as titanium silicalites, particularly “TS-1” (having an MFI topology analogous to that of the ZSM-5 aluminosilicate zeolites), “TS-2” (having an MEL topology analogous to that of the ZSM-11 aluminosilicate zeolites), and “TS-3” (as described in Belgian Pat. No. 1,001,038). Titanium-containing molecular sieves having framework structures isomorphous to zeolite beta, mordenite, ZSM-48, ZSM-12, and MCM-41 are also suitable for use. The titanium zeolites preferably contain no elements other than titanium, silicon, and oxygen in the lattice framework, although minor amounts of boron, iron, aluminum, sodium, potassium, copper and the like may be present.

The typical amount of noble metal present in the noble metal-containing titanium or vanadium zeolite will be in the range of from about 0.001 to 20 weight percent, preferably 0.005 to 10 weight percent, and particularly 0.01 to 5 weight percent. The manner in which the noble metal is incorporated into the catalyst is not considered to be particularly critical. For example, the noble metal may be supported on the zeolite by impregnation or the like. Alternatively, the noble metal can be incorporated into the zeolite by ion-exchange with, for example, tetraammine palladium dichloride.

There are no particular restrictions regarding the choice of noble metal compound used as the source of noble metal. For example, suitable compounds include the nitrates, sulfates, halides (e.g., chlorides, bromides), carboxylates (e.g. acetate), and amine complexes of the noble metal. The noble metal may be in an oxidation state anywhere from 0 to +4 or any combination of such oxidation states. To achieve the desired oxidation state or combination of oxidation states, the noble metal compound may be calcined, reduced, or a combination thereof. Satisfactory catalytic performance can, however, be attained without any pre-reduction. To achieve the active state of noble metal, the noble metal-containing titanium or vanadium zeolite may undergo pretreatment such as thermal treatment in nitrogen, vacuum, hydrogen, or air.

The noble metal-containing titanium or vanadium zeolite catalyst may also comprise a mixture of palladium-containing titanium or vanadium zeolite and palladium-free titanium or vanadium zeolite. The palladium-free titanium or vanadium zeolite is a titanium or vanadium-containing molecular sieve that is free of added palladium. The addition of a palladium-free titanium or vanadium zeolite has proven beneficial to productivity of the palladium that is present in the catalyst.

The noble metal-containing titanium or vanadium zeolite catalyst may be used in the epoxidation process as a powder or as a large particle size solid. Preferably, the noble metal-containing titanium or vanadium zeolite is spray dried, pelletized or extruded prior to use in epoxidation. If spray dried, pelletized or extruded, the catalyst may additionally comprise a binder or the like and may be molded, spray dried, shaped or extruded into any desired form prior to use in epoxidation.

The noble metal-containing titanium or vanadium zeolite catalysts are useful for catalyzing the epoxidation of olefins with oxygen and hydrogen. This epoxidation process comprises contacting an olefin, oxygen, and hydrogen in a liquid medium in the presence of the catalyst. Suitable olefins include any olefin having at least one carbon-carbon double bond, and generally from 2 to 60 carbon atoms. Preferably the olefin is an acyclic alkene of from 2 to 30 carbon atoms; the process of the invention is particularly suitable for epoxidizing C₂-C₆ olefins. More than one double bond may be present, as in a diene or triene for example. The olefin may be a hydrocarbon (i.e., contain only carbon and hydrogen atoms) or may contain functional groups such as halide, carboxyl, hydroxyl, ether, carbonyl, cyano, or nitro groups, or the like. The process of the invention is especially useful for converting propylene to propylene oxide.

Oxygen and hydrogen are also required for the epoxidation process. Although any sources of oxygen and hydrogen are suitable, molecular oxygen and molecular hydrogen are preferred.

The epoxidation reaction is carried out at a temperature effective to achieve the desired olefin epoxidation, preferably at temperatures in the range of 0-250° C., more preferably, 20-100° C. The molar ratio of hydrogen to oxygen can usually be varied in the range of H₂:O₂=1:10 to 5:1 and is especially favorable at 1:5 to 2:1. The molar ratio of oxygen to olefin is usually 2:1 to 1:20, and preferably 1:1 to 1:10. Relatively high oxygen to olefin molar ratios (e.g., 1:1 to 1:3) may be advantageous for certain olefins. A carrier gas may also be used in the epoxidation process in addition to olefin, hydrogen, and oxygen. As the carrier gas, any desired inert gas can be used. The molar ratio of olefin to carrier gas is then usually in the range of 100:1 to 1:10 and especially 20:1 to 1:10.

As the inert gas carrier, noble gases such as helium, neon, and argon are suitable in addition to nitrogen and carbon dioxide. Saturated hydrocarbons with 1-8, especially 1-6, and preferably with 1-4 carbon atoms, e.g., methane, ethane, propane, and n-butane, are also suitable. Nitrogen and saturated C₁-C₄ hydrocarbons are the preferred inert carrier gases. Mixtures of the listed inert carrier gases can also be used.

Specifically in the epoxidation of propylene, propane can be supplied in such a way that, in the presence of an appropriate excess of carrier gas, the explosive limits of mixtures of propylene, propane, hydrogen, and oxygen are safely avoided and thus no explosive mixture can form in the reactor or in the feed and discharge lines.

The epoxidation reaction may be carried out in the liquid phase or in the gas phase. The epoxidation reaction is typically carried out in a liquid medium. It is advantageous to work at a pressure of 1-100 bars and in the presence of one or more solvents. Suitable reaction solvents include, but are not limited to, alcohols, water, supercritical CO₂, or mixtures thereof. Suitable alcohols include C₁-C₄ alcohols such as methanol, ethanol, isopropanol, and tert-butanol, or mixtures thereof. Fluorinated alcohols can be used. It is preferable to use mixtures of the cited alcohols with water. For the liquid-phase epoxidation process, the catalyst is preferably in the form of a suspension or fixed-bed. The process may be performed using a continuous flow, semi-batch or batch mode of operation.

The olefin epoxidation reaction may be run in the presence of a buffer. The buffer will typically be added to the solvent to form a buffer solution in order to inhibit the ring opening of epoxides to glycols and/or glycol ethers. Buffers are well known in the art. Buffers useful in this invention include any suitable salts of oxyacids, the nature and proportions of which in the mixture, are such that the pH of their solutions may range from 3 to 10, preferably from 4 to 9 and more preferably from 5 to 8. Suitable salts of oxyacids contain an anion and cation. The anion portion of the salt may include anions such as phosphate, carbonate, bicarbonate, carboxylates (e.g., acetate, phthalate, and the like), citrate, borate, hydroxide, silicate, aluminosilicate, or the like. The cation portion of the salt may include cations such as ammonium, alkylammoniums (e.g., tetraalkylammoniums, pyridiniums, and the like), alkali metals, alkaline earth metals, or the like. Cation examples include NH₄, NBu₄, NMe₄, Li, Na, K, Cs, Mg, and Ca cations. More preferred buffers include alkali metal phosphate and ammonium phosphate buffers. Buffers may preferably contain a combination of more than one suitable salt. Typically, the concentration of buffer in the solvent is from about 0.0001 M to about 1 M, preferably from about 0.001 M to about 0.3 M. The buffer useful in this invention may also include the addition of ammonia gas to the reaction system.

Obviously, there is no need to utilize the regeneration process of this invention until the epoxidation activity, or selectivity, of the catalyst has diminished to an unacceptable level. Typically, however, it will be economically desirable to reactivate the catalyst when its activity is between 0.1 and 75 percent of its activity when freshly prepared, as measured by the rate at which epoxide and derivatives (such as glycols and glycol ethers) are formed. The length of time between the start of epoxidation and the point at which catalyst activity drops to a level where regeneration is to be initiated will be dependent upon many reaction parameters, including the identities of the olefin, the solvent, the space velocities of the reactants, the reaction temperature, and the nature and amount of impurities and other changes in the catalyst associated with deactivation.

Prior to regeneration, the spent catalyst may be separated in solid form from any liquid components of the reaction mixture. If so separated, it is not necessary to completely dry the recovered catalyst prior to regeneration since any minor amounts of epoxidation reaction solvent, reactants, and the like adsorbed on the catalyst can be readily removed and disposed of during the regeneration. Where the catalyst has been deployed in the form of a slurry, it may be readily collected by filtration, centrifugation, decantation, or other such mechanical means and then transferred into a vessel which is suitable for carrying out the regeneration. Alternatively, the catalyst may remain in the slurry reactor without being collected and then contacted with water or a water and alcohol mixture to regenerate the catalyst. Where the catalyst has been used as a fixed bed, the liquid components may be simply drained or pumped away from the spent catalyst and regeneration conducted in the same vessel as the catalytic epoxidation process.

The regeneration procedure of the invention is accomplished by contacting the spent catalyst with water or a mixture of alcohol and water at a temperature of 25° C. to 200° C. A mixture of alcohol and water is especially preferred. Suitable alcohols include C₁-C₁₀ aliphatic alcohols and C₇-C₁₂ aralkyl alcohols. Illustrative C₁-C₁₀ aliphatic aliphatic alcohols include straight chain, branched and cyclic mono-alcohols such as methanol, ethanol, n-propyl alcohol, isopropyl alcohol, n-butanol, sec-butanol, iso-butanol, t-butyl alcohol, cyclohexanol, 2-ethyl hexyl alcohol, and the like. Suitable C₁-C₁₀ aliphatic alcohols also include diols and oligomers and mono-ethers thereof such as ethylene glycol, diethylene glycol, propylene glycol, tripropylene glycol, propylene glycol mono-methyl ether, 1,4-butanediol, neopentyl glycol, 1,3-propanediol, 2-methyl-1,3-propanediol, and the like. Examples of C₇-C₁₂ aralkyl alcohols include those alcohols wherein an alkyl group is substituted with both a hydroxy group and an aromatic group such as, for example, benzyl alcohol, alpha-methyl benzyl alcohol, alpha-ethyl benzyl alcohol, dimethyl benzyl alcohol, and the like. Preferred alcohols include C₁-C₄ aliphatic alcohols such as methanol, ethanol, n-propyl alcohol, isopropyl alcohol, n-butanol, sec-butanol, iso-butanol, and t-butyl alcohol. Methanol is especially preferred. The alcohol:water volume ratio is preferably from about 0.5 to about 5. Any conventional catalyst washing procedure is suitable.

Typically, the water or alcohol:water mixture is contacted with the spent catalyst at a temperature of 25° C. to 200° C. and for a time effective to improve the activity of the catalyst (as measured by the rate at which epoxide and derivatives, such as glycols and glycol ethers, are formed). Preferred temperatures are within the range of from 50° C. to 120° C. Pressures of from 0 to 1000 psig are generally useful for purposes of this invention. Preferably, the pressure is sufficient to maintain the contact solvent substantially as a liquid phase and also to improve the ability of the solvent to reach all available micropores. Preferably, the agitation of the catalyst slurry in the wash solution by mechanical stirring can restore activity in the used catalyst.

In the contacting procedure, catalyst impurities are extracted into the water or alcohol/water mixture and removed from the catalyst surface, so “contacting” also encompasses separating the water or alcohol/water mixture from the used catalyst. For instance, after contacting with water or an alcohol/water mixture, the reactivated catalyst may be recollected by filtration, centrifugation, decantation, or other such mechanical means and then transferred back into the epoxidation reactor following the regeneration. In the case where the used catalyst remains in the epoxidation reactor for the regeneration procedure, the used catalyst may be contacted with water or alcohol/water mixture to regenerate the used catalyst prior to removing the wash liquid from the reactor for further epoxidation. In a fixed bed embodiment of the invention, it is preferred to pass the water or alcohol/water mixture through the catalyst as a flowing stream such that impurities washed from the catalyst are continually carried away from the fixed bed. The wash liquid could be recirculated if the impurity levels are negligible or if there is a filter or adsorbent bed in the wash liquid stream to remove the impurities. Liquid hourly space velocities in the range of from 0.1 to 24 are generally satisfactory.

When the epoxidation reaction is carried out in a fixed bed or a continuously agitated bath, the spent catalyst may be contacted with the regeneration solvent by supplying the water or alcohol/water mixture instead of the epoxidation reaction raw materials to the reactor. When the epoxidation reaction is performed as a batch-type reaction, the catalyst may be solvent washed by removing the supernatant solution following epoxidation, introducing the water or alcohol/water mixture to the reactor, agitating the solvent (preferably, while heating at a moderately elevated temperature), and again removing the supernatant solution.

Where the epoxidation reaction is performed in water or a mixture of alcohol and water, a preferred embodiment is to turn off the flow of oxygen and hydrogen gas to the reactor and contact the used catalyst under continuous flow with the water or alcohol/water mixture to regenerate the used catalyst. In this embodiment, the buffer used in the epoxidation reaction may be contacted with the used catalyst in addition to the water or alcohol/water mixture.

Following wash regeneration, the regenerated catalyst may be further treated if so desired prior to reuse in an oxidation reaction to further modify its catalytic properties. For example, the reactivated catalyst may be calcined by heating to an elevated temperature (e.g., 300-600° C.) in the presence of oxygen. The reactivated catalyst may also be reduced in the presence of hydrogen at temperatures above 20° C., either following calcination or without calcination. Calcination and reduction are not necessary to the regeneration procedure of the invention. Preferably, the regeneration procedure of the invention consists only of the contacting of the spent catalyst with water or an alcohol:water mixture at a temperature of 25° C. to 200° C.

The regenerated catalyst which has been reactivated in accordance with the process of the invention may be admixed with freshly prepared catalyst prior to reuse, if so desired, or used directly.

The following examples merely illustrate the invention. Those skilled in the art will recognize many variations that are within the spirit of the invention and scope of the claims.

### EXAMPLE 1

### Catalyst Preparation

Spray dried TS-1 (160 g, 80% TS-1, silica binder, 1.74 wt. % Ti, calcined at 550° C. in air) is slurried in deionized water (400 grams) and the pH is adjusted to 7.0 using 3 wt. % aqueous ammonium hydroxide. The slurry is mixed for 5 minutes and an aqueous solution of tetra ammine palladium dinitrate (3.36 g aqueous solution containing 5.37 wt % Pd, further diluted with 29.44 g of deionized water) is added with mixing over 5 minutes. The pH is adjusted to 7.5 with 3 wt. % ammonium hydroxide and the slurry is agitated at 30° C. for 1 hour. The slurry is filtered and the filter cake is washed three times by reslurrying in deionized water (240 g) and filtering again. The solids are air dried overnight and then dried in a vacuum oven at 50° C. for 6 hours. The dried solid contains 0.1 wt. % Pd and 1.74 wt. % Ti.

The dried solids are oven calcined in air by heating from 23 to 110° C. at 10° C./min and holding at 110° C. for 4 hours, then heating to 300° C. at 2° C./min and holding at 300° C. for 4 hours. The calcined solids are then transferred to a quartz tube, heated to 50° C. and treated with 5 vol. % hydrogen in nitrogen (100 cc/min) for 4 hours. After the hydrogen treatment, nitrogen is passed through the solids for 1 hour before cooling to 23° C. and recovering Catalyst 1.

### EXAMPLE 2

### Propylene Epoxidation Procedure

A 1-liter stainless steel reactor is charged with 60 grams of Catalyst 1, deionized water (150 g), and methanol (450 g). The reactor contains a dip tube equipped with a 7 micron filter to remove the liquids and retain the solid catalyst in the reactor while the fed gases are removed overhead. A solvent pump is charged with a mixture of methanol/water (77/23 wt. %) and an ISCO pump is charged with aqueous solution of ammonium phosphate prepared by adding ammonium hydroxide to an aqueous solution of ammonium dihydrogen phosphate to a pH of 7.2. The reactor is then pressurized to 500 psig with a feed consisting of hydrogen (3.9 vol. %), oxygen (4.1 vol. %), propylene (9 vol. %), methane (0.5 vol. %), and the balance nitrogen. Combined gas flow rates are 510 standard L/hr. Liquid solvent and the ammonium phosphate solution are flowed continuously through the reactor at a rate of 100 mL/hr and 2 mL/hr, respectively. The pressure in the reactor is maintained at 500 psig via a back pressure regulator and liquid level is controlled with a research control valve. The reactor is stirred at 500 rpm and the reaction mixture is heated to 60° C. The gaseous effluent and liquid phase are analyzed by an online gas chromatography (GC). Propylene oxide and equivalents (“POE”), which include propylene oxide, propylene glycol (“PG”), and glycol ethers, are produced during the reaction, in addition to propane formed by the hydrogenation of propylene.

After several weeks of operation, the used catalyst is recovered from the reactor and washed with deionized water before drying in vacuum at 50° C. The used catalyst is designated Catalyst 2. Catalyst 2 contains 2.6 wt. % C, 0.04 wt. % P, and 0.1 wt. % Pd.

### EXAMPLE 3

### Catalyst Regeneration by Washing

Regeneration 3A: Used Catalyst 2 (˜2 g) is placed in a 100 ml stainless steel Parr reactor and a 50:50 volume ratio methanol:water mixture is added (40 g of deionized water and 32 g of 99.9% pure methanol). A Teflon stir bar is added and the Parr reactor is then pressurized/depressurized with 100 psig nitrogen to remove residual air from the reactor. The reactor is padded with 100 psig of nitrogen, the stirrer spun at 300 rpm, and the reactor heated to raise the temperature of the inside liquid to 150° C. as measured by an internal thermocouple. Pressure in the reactor rose to 215 psig when the internal temperature reached 150° C. The reactor is held at these conditions for 24 hours before cooling to room temperature and then venting off the reactor pressure to 1 atm. The washed catalyst slurry is then vacuum filtered from the mother liquor using a 0.22 micron filter followed by several rinses using 20 ml aliquots of deionized water. The washed catalyst is then air dried on the filter for several hours before placing in a vacuum oven at 81° C. and 30″ water vacuum for 4 hrs. The net weight of recovered washed Catalyst 3A is 1.82 g. Catalyst 3A contains 0.09 wt. % Pd, 1.8 wt. % Ti, 0.52 wt. % C, and 0.01 wt. % P.

Regeneration 3B: Used Catalyst 2 is regenerated according to the same procedure as in Regeneration 3A except that the wash is performed at 100° C. and the pressure in the reactor rose to 138 psig at 100° C. Recovered Catalyst 3B contains 0.09 wt. % Pd, 1.6 wt. % Ti, 0.57 wt. % C, and 0.01 wt. % P.0

Regeneration 3C: Used Catalyst 2 is regenerated according to the same procedure as in Regeneration 3A except that used catalyst is placed in a 300 ml stainless steel Parr reactor with 90 mL of deionized water and 90 mL of methanol. The wash is performed at 400 psig and 80° C. and the pressure in the reactor rose to 490 psig at 80° C. Recovered Catalyst 3C contains 0.1 wt. % Pd, 1.8 wt. % Ti, 0.78 wt. % C, and 0.01 wt. % P.

Regeneration 3D: Used Catalyst 2 is regenerated according to the same procedure as in Regeneration 3C except that wash is performed at 60° C. and the pressure in the reactor rose to 460 psig upon heating to 60° C. Recovered Catalyst 3D contains 0.09 wt. % Pd, 1.8 wt. % Ti, 0.85 wt. % C, and 0.01 wt. % P.

Regeneration 3E: Used Catalyst 2 is regenerated according to the same procedure as in Regeneration 3C except that a 80:20 volume ratio methanol:water mixture is added (36.14 g of deionized water and 144.18 g of methanol). The wash is performed at 100° C. and the pressure in the reactor rose to 510 psig upon heating to 100° C. Recovered Catalyst 3E contains 0.10 wt. % Pd, 1.8 wt. % Ti, 0.46 wt. % C, and 0.01 wt. % P.

Regeneration 3F: Used Catalyst 2 is regenerated according to the same procedure as in Regeneration 3C except that a 20:80 volume ratio methanol:water mixture is added (144 g of deionized water and 36 g of methanol). The wash is performed at 100° C. and the pressure in the reactor rose to 530 psig upon heating to 100° C. Recovered Catalyst 3F contains 0.09 wt. % Pd, 1.7 wt. % Ti, 0.88 wt. % C, and 0.007 wt. % P.

Comparative Regeneration 3G: Used Catalyst 2 is regenerated according to the same procedure as in Regeneration 3C except that only methanol (180.5 g) is used as the wash solvent. The wash is performed at 100° C. and the pressure in the reactor rose to 530 psig upon heating to 100° C. Recovered Comparative Catalyst 3G contains 0.09 wt. % Pd, 1.8 wt. % Ti, 1.02 wt. % C, and 0.02 wt. % P.

Regeneration 3H: Used Catalyst 2 is regenerated according to the same procedure as in Regeneration 3C except that only water (180.1 g) is used as the wash solvent. The wash is performed at 100° C. and the pressure in the reactor rose to 520 psig upon heating to 100° C. Recovered Catalyst 3H contains 0.09 wt. % Pd, 1.8 wt. % Ti, 1.49 wt. % C, and 0.02 wt. % P.

Regeneration 31: Used Catalyst 2 (2.5 g) is regenerated according to the same procedure as in Regeneration 3C except that a 50:50 volume ratio t-butyl alcohol:water mixture is added (90 g of deionized water and 71.2 g of t-butyl alcohol). The wash is performed at 100° C. and the pressure in the reactor rose to 550 psig upon heating to 100° C. Recovered Catalyst 31 contains 0.09 wt. % Pd, 1.8 wt. % Ti, 1.09 wt. % C, and 0.02 wt. % P.

Regeneration 3J: Used Catalyst 2 (2.5 g) is regenerated according to the same procedure as in Regeneration 3C except that a 25:25:50 volume ratio t-butyl alcohol:methanol:water mixture is added (90.2 g of deionized water, 37.55 g og methanol, and 35.55 g of t-butyl alcohol). The wash is performed at 100° C. and the pressure in the reactor rose to 550 psig upon heating to 100° C. Recovered Catalyst 3J contains 0.09 wt. % Pd, 1.8 wt. % Ti, 0.80 wt. % C, and 0.02 wt. % P.

### EXAMPLE 4

### Propylene Epoxidation Procedure

The fresh, used and regenerated catalysts are tested in propylene epoxidation (regenerated catalyst 3H is tested twice) according to the following general procedure.

A 300 cc stainless steel reactor is charged with 0.7 grams of catalyst, 13 grams of a buffer (0.1 M aqueous ammonium phosphate, pH=6), and 100 grams of methanol. The reactor is then charged to 300 psig of a feed consisting of 2% hydrogen, 4% oxygen, 5% propylene, 0.5% methane and the balance nitrogen (volume %). The pressure in the reactor is maintained at 300 psig via a back pressure regulator with the feed gases passed continuously through the reactor at 1600 cc/min (measured at 23° C. and one atmosphere pressure). In order to maintain a constant solvent level in the reactor during the run, the oxygen, nitrogen and propylene feeds are passed through a two-liter stainless steel vessel (saturator) preceding the reactor containing 1.5 liters of methanol. The reactor is stirred at 1500 rpm. The reaction mixture is heated to 60° C. and the gaseous effluent is analyzed by an online GC every hour and the liquid analyzed by offline GC at the end of the 18 hour run. Propylene oxide and equivalents (“POE”), which include propylene oxide (“PO”), propylene glycol, and glycol ethers, are produced during the reaction, in addition to propane formed by the hydrogenation of propylene. The results of the GC analyses are used to calculate the selectivities shown in Table 1.

TABLE 1
COMPARISON OF CATALYST ACTIVITY FOLLOWING
REGENERATION

| | | | PO/POE | Propane |
|---|---|---|---|---|
| | | | Selectivity | Selectivity |
| Catalyst | Treatment | Productivity ¹ | (%) ² | (%) ³ |
| 1 * | Fresh | 0.23 | 93 | 74 |
| 2 * | Used | 0.18 | 93 | 82 |
| 3A | 50:50 MeOH.H₂O | 0.21 | 94 | 66 |
| | 150° C. | | | |
| 3B | 50:50 MeOH:H₂O | 0.24 | 88 | 74 |
| | 100° C. | | | |
| 3C | 50:50 MeOH:H₂O | 0.21 | 94 | 68 |
| | 80° C. | | | |
| 3D | 50:50 MeOH:H₂O | | | |
| | 60° C. | 0.22 | 93 | 69 |
| 3E | 80:20 MeOH:H₂O | 0.2 | 93 | 70 |
| | 100° C. | | | |
| 3F | 20:80 MeOH:H₂O | 0.23 | 94 | 58 |
| | 100° C. | | | |
| 3G * | MeOH | 0.22 | 94 | 68 |
| | 100° C. | | | |
| 3H | H₂O | 0.28 | 93 | 50 |
| | 100° C. | 0.24 | 93 | 56 |
| 3I | 50:50 TBA:H₂O | 0.25 | 93 | 50 |
| | 100° C. | | | |
| 3J | 25:25:50 | 0.24 | 92 | 56 |
| | TBA:MeOH:H₂O | | | |
| | 100° C. | | | |

* Comparative Example
¹ Productivity = grams POE produced/gram of catalyst per hour.
² PO/POE Selectivity = moles PO/(moles PO + moles glycols + moles glycol ethers) * 100.
³ Propane Selectivity = moles propane * 100/(moles POE + moles propane).

1. A method of regenerating a used noble metal-containing titanium or vanadium zeolite catalyst that has been used to catalyze the epoxidation of an olefin with hydrogen and oxygen, said method comprising contacting the used catalyst with water or a mixture of an alcohol and water at a temperature of 25° C. to 200° C. to reactivate the used catalyst.

2. The method of claim 1 wherein the used catalyst comprises titanium silicalite and palladium.

3. The method of claim 1 wherein the used catalyst comprises titanium silicalite, palladium, and one or more metals selected from the group consisting of gold and platinum.

4. The method of claim 1 wherein the used catalyst comprises palladium-containing titanium or vanadium zeolite and palladium-free titanium or vanadium zeolite.

5. The method of claim 1 wherein the alcohol is selected from the group consisting of C₁-C₁₀ aliphatic alcohols and C₇-C₁₂ aralkyl alcohols.

6. The method of claim 1 wherein the alcohol is selected from the group consisting of methanol, ethanol, n-propyl alcohol, isopropyl alcohol, n-butanol, sec-butanol, iso-butanol, and t-butyl alcohol.

7. The method of claim 1 wherein the alcohol is methanol.

8. The method of claim 1 wherein the temperature is from 50° C. to 120° C.

9. The method of claim 1 wherein the alcohol:water volume ratio is from 0.5 to 5.

10. The method of claim 1 wherein the contacting is performed for 0.5 hours to 12 hours.

11. The process of claim 1 wherein the olefin is a C₂-C₆ olefin.

12. The process of claim 1 wherein the olefin is propylene.

13. A method of regenerating a used palladium-containing titanium silicalite catalyst which has been used to catalyze the epoxidation of propylene with hydrogen and oxygen, said method comprising contacting the used catalyst with a mixture of a C₁-C₄ aliphatic alcohol and water at a temperature of 50° C. to 120° C. to reactivate the used catalyst.

14. The method of claim 13 wherein the used catalyst comprises titanium silicalite, palladium, and one or more metals selected from the group consisting of gold and platinum.

15. The method of claim 13 wherein the used catalyst comprises palladium-containing titanium silicalite and palladium-free titanium silicalite.

16. The method of claim 13 wherein the alcohol is methanol.

17. The method of claim 13 wherein the alcohol:water volume ratio is from about 0.5 to about 5.
